(19) United States
(12) Patent Application Publication
(10) Pub. No.: US 2010/0155983 A1
(43) Pub. Date: Jun. 24, 2010

(54) Malleable vase and method of producing said vase

(76) Inventor: James Armstrong, San Clemente, CA (US)

Correspondence Address: ZUBER & TAILLIEU LLP, 10866 WILSHIRE BLVD., SUITE 300, LOS ANGELES, CA, 90024, US

(21) Appl. No.: 12/660,654

(22) Filed: Mar. 1, 2010

Related U.S. Application Data
(63) Continuation of application No. 11/603,803, filed on Nov. 21, 2006.

(51) Int. Cl. B29C 39/12; B29C 39/02

(52) U.S. Cl. 264/78; 264/299

(57) ABSTRACT

A malleable vase constructed from silicone rubber or other malleable material and a method of producing said vase.

### RELATED CASES

This is a continuation application of co-pending Ser. No. 11/603,803, entitled “Malleable Vase and Method of Producing Said Vase”, filed on Nov. 21, 2006, whose disclosures are incorporated by this reference as though fully set forth herein.

### BACKGROUND OF THE INVENTION

The present invention relates to a malleable vase or receptacle for holding plants and/or flowers.

Prior art vases are generally configured as vertically oriented receptacles constructed from rigid material such as plastic, glass, or crystal. Shortcomings of prior art vases are due in part to the rigid nature of the materials from which they are often constructed from. Because of the inflexible nature of the materials from which prior art vases are constructed from, a user cannot generally use a single prior art vase to accommodate a wide variety of plant and flower arrangement sizes. Prior art vases are often fragile and must be carefully stored when not in use. Prior art vases may also be inconvenient to store for users who possess limited storage space.

While several inventions have attempted to resolve some of the above issues, only the present invention addresses all of the above shortcomings. U.S. Pat. No. 6,061,955 teaches a collapsible flower vase assembly. While this vase does address issues related to storage and breakage, the vase is intended only for use with long stem flowers. U.S. Pat. No. 5,403,634 teaches a collapsible flower vase comprising a sleeve member, collar, and a flexible, water-tight bag which engages the collars. This vase also addresses storage issues but does not allow for flexibility in the size and type of arrangements displayed. U.S. Pat. No. 4,910,913 teaches a collapsible vase including paper components. This vase does not form a water-tight seal.

The present invention is a vase comprised of a malleable material that allows a user to provide a variety of plant and flower arrangements of varying heights and widths. Because the material is flexible and durable, it can be compressed for convenient storage and cannot be easily damaged or broken. Accordingly, the present invention addresses many of the shortcomings of prior art vases and receptacles.

It is an object of the present invention to provide a malleable vase that can accommodate flower and plant arrangements of a variety of widths and heights.

It is a further object of the present invention to provide a malleable vase that can be produced relatively simply and inexpensively.

It is an additional object of the present invention to provide a malleable vase that is not easily prone to damage or breakage.

### SUMMARY OF INVENTION

The present invention relates to a malleable vase that can be temporarily configured to assume a variety of shapes. In the preferred embodiment of the present invention, the vase is constructed from a silicone rubber.

### BRIEF DESCRIPTION OF DRAWINGS

FIGS. 1-4 show a method by which the present invention is produced.

FIG. 5 shows one configuration of the vase.

FIG. 6 shows a second configuration of the vase.

FIG. 7 shows a third configuration of the vase.

FIG. 8 shows a fourth configuration of the vase.

### DETAILED DESCRIPTION OF THE PREFERRED EMBODIMENT OF THE PRESENT INVENTION

The present invention may be constructed from a variety of malleable materials. In the preferred embodiment it is constructed from silicone rubber. The preferred embodiment of the present invention incorporates a material with the trade name SORTA-CLEAR a product of Smooth-On, Inc which is a clear, silicone rubber composition. Other silicone rubber compositions may be employed, however, and still fall within the scope of the present invention.

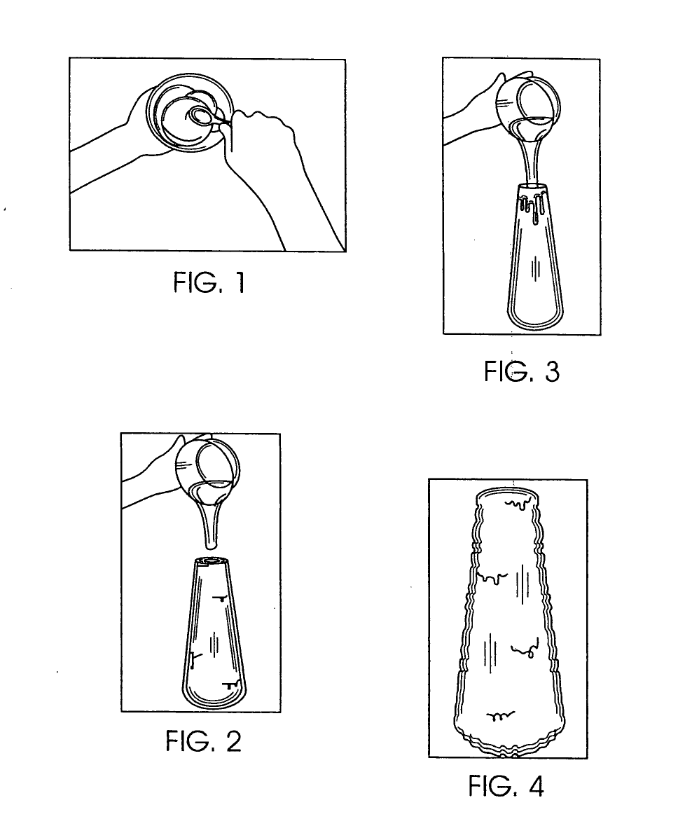

FIGS. 1-4 depict a novel method of producing the present invention. FIG. 1 demonstrates the preparation of a bowl of silicone rubber. The silicone rubber may be prepared using techniques known in the art, following manufacturer recommendations. The constituents of the silicone rubber material are combined in a ratio specified by the manufacturer. A material having a viscous, liquid form should result from the mixture. In the preferred embodiment of the present invention, four separate bowls of the silicone rubber material are prepared. Each of the bowls will be used to form one of four layers of silicone rubber making up the preferred embodiment of the present invention.

FIG. 2 depicts the pouring of a bowl of silicone rubber onto a mold. The mold may be constructed from plastic or any other suitable, rigid material. The silicone is drizzled onto the mold so that an uneven surface area may form. A first layer of silicone is allowed to cure until it is tacky to touch. This may take 16 hours. Because the first layer is drizzled onto the mold, uneven surfaces form, providing a textured appearance to the first layer of silicone material. When a second layer of material is poured onto the mold, additional variances to the surface area of the silicone material are created. After pouring, the second layer is also allowed to cure. In the preferred embodiment of the present invention, the two silicone layers are maintained in their translucent color.

FIG. 3 shows the pouring of a third layer of silicone rubber. Dye may be added to the silicone material to be used for the third layer using dye techniques known in the art. Vibrant colors may be chosen to enhance the effect. The third layer is allowed to cure before the pouring of a final layer.

FIG. 4 shows the pouring of a final translucent layer, which allows the color from the third layer to be visible. The fourth layer of silicone material further adds to the textured appearance of the present invention. When the fourth layer is fully cured the present invention may be used to hold plants, flowers and water. The above four steps may be performed by hand or by automated means.

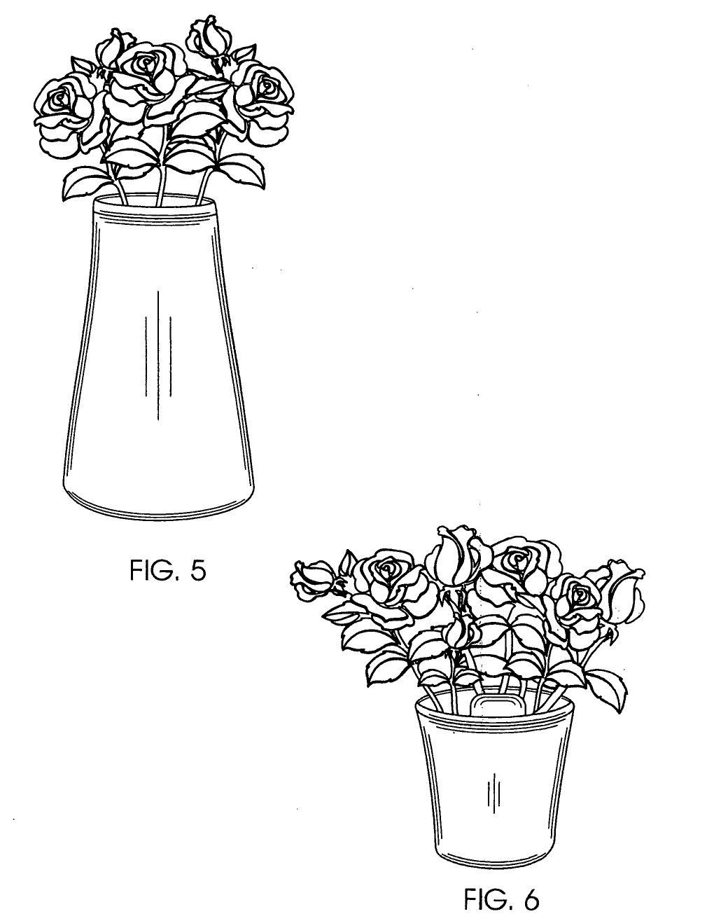

The physical properties of the silicone rubber material allow for the cured material to withstand strong tear and tensile strength. As a result, the present invention may assume various configurations depending on the preferences of the user. FIG. 5 shows the vase in its most elongated position. The configuration of FIG. 5 most closely resembles the mold from which it was formed. The configuration of FIG. 5 may be the most suitable configuration for accommodating long stemmed flowers and plants.

FIG. 6 shows a second configuration of the present invention. This configuration is provided by simply pushing the base portion of the vase in FIG. 5 upwards towards the mouth of the vase. This movement results in decreasing the resulting height of the vase. This configuration may be suitable for displaying plants and flowers that would be fully obscured by the vase depicted in FIG. 5 if the plants and flowers were to be placed within it.

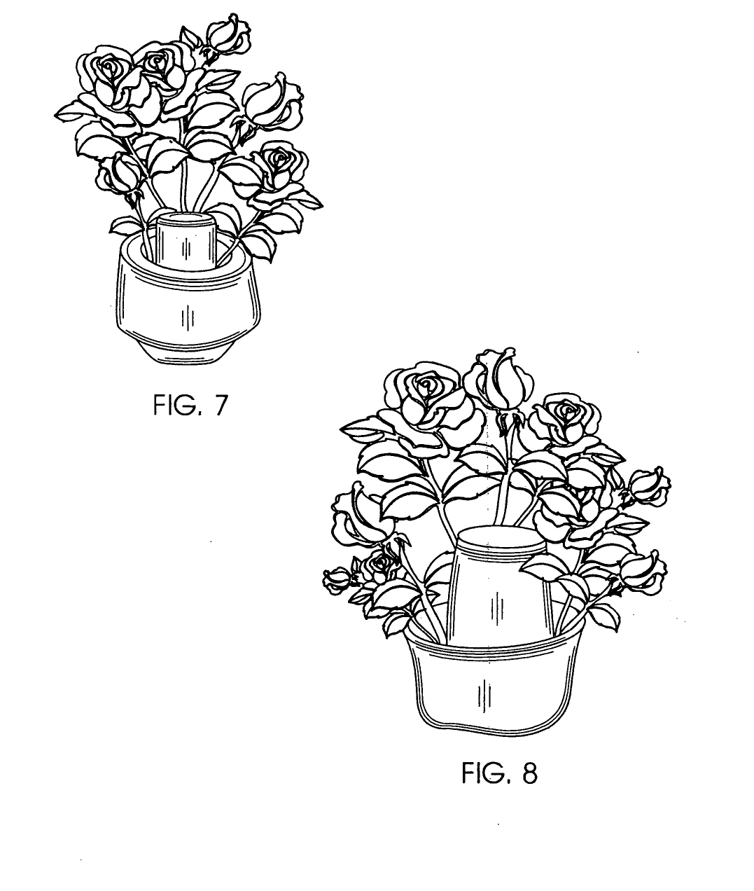

FIG. 7 depicts a configuration of the vase when the mouth of the vase in FIG. 6 is folded outwards. The resulting configuration of the vase produces a vase having a significantly different appearance when compared to the prior two configurations. This configuration may be suitable for displaying plants and flowers that would be otherwise obscured by the vase depicted in FIG. 6.

FIG. 8 depicts yet another configuration of the present invention. When the be formed. This configuration may be suitable for displaying plants and flowers having an even shorter height than those ideally displayed in the configuration of FIG. 7.

FIGS. 5-8 are only representative of some of the configurations of the vase that may be formed with the present invention. Because of the flexibility of the silicone material, various configurations of the vase can be formed, unformed, and re-formed again. The present invention allows for numerous configurations to be formed that best complement the plant and flower arrangement being displayed.

In summary, the present invention is a novel, inventive vase that addresses many of the shortcomings in the art. With respect to the above description, it is to be realized that the optimum dimensional relationships for the parts of the invention, to include variations in size, materials, shape, form, function, manner and use are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, while still falling within the scope of the invention. Finally, nothing in this disclosure is intended to limit the production method of the vase to hand production, and mass production methods of producing the vase are also in keeping with the spirit of the invention.

1-2. (canceled)

3. A method of producing a malleable vase comprising the steps of:
pouring silicone rubber material into a mold; and
allowing the silicone rubber to cure at least until tacky to touch.

4. A method of producing a malleable vase comprising the steps of:
Pouring silicone rubber material into multiple, separate bowls;
Pouring a bowl of silicone rubber material into a mold;
Allowing the silicone rubber to cure at least until tacky to touch;
Continuing said preceding steps with the remaining bowls of silicone material until no bowls of material are remaining.

5. The method of claim 4 further comprising a step of adding dye to one of the bowls of material prior to pouring the material onto the mold so that a color is visible within the vase.
